(19) United States
(12) Patent Application Publication
(10) Pub. No.: US 2012/0092424 A1
(43) Pub. Date: Apr. 19, 2012

(54) Inkjet Printers

(75) Inventors: James Edward Fox, Hertfordshire (GB); Olivier Morel, Essex (GB)

(73) Assignee: XENNIA TECHNOLOGY LIMITED, Hertfordshire (GB)

(21) Appl. No.: 13/377,818

(22) PCT Filed: Jun. 23, 2010
(86) PCT No.: PCT/GB2010/051039

§ 371 Date: Dec. 12, 2011

(30) Foreign Application Priority Data
Jun. 25, 2009 (GB) 0910924.0

(51) Int. Cl. B41J 2/045; B41J 2/175; C25D 3/48; B05D 5/12

(52) U.S. Cl. 347/71; 427/123; 347/85; 205/261

(57) ABSTRACT

An inkjet printhead (10) has at least one electrode, with exposed metal region(s) (16) of the electrode surface having a coating of inert metal, In use of the printhead, the inert metal coating functions to protect the underlying metal surface of the electrode, and in particular protects the electrode from corrosion to aqueous or other ion-containing inks. The invention is of particular benefit in piezoelectric printheads.

### FIELD OF THE INVENTION

This invention relates to inkjet printers, and particularly concerns printheads for inkjet printers.

### BACKGROUND TO THE INVENTION

In many inkjet printheads, internal electrodes that are used to activate the printhead and create ink droplet ejection come into contact with the ink in the printhead in use. This can lead to corrosion of metal conductors used to form the electrodes, with is electrodes in an inkjet printhead typically being formed from a conductive metal such as copper or nickel, or a combination of such metals. This situation is especially prevalent when using electrically conductive inks (aqueous and non aqueous). Electrode corrosion is particularly problematic in piezoelectric printheads, but also arises in thermal printheads, and places constraints on the inks that can be used in the printheads.

Methods of attempting to protect printhead electrodes from corrosion are known, the most common of which is coating with Parylene (Parylene is a Trade Mark) polymer materials. The Parylene material is applied to the metal electrode surface, typically by a vapour deposition process, and forms an insulating layer between the electrode and the ink. However, it is found in practice that even Parylene-coated electrodes are susceptible to corrosion when using inks containing solvents that will readily support ions, such as water, and that inkjet printheads with such electrodes do not have an acceptable lifetime with such inks.

It is therefore desirable that methods are developed to prevent corrosion, or improve corrosion resistance, of an inkjet printhead, so that a wider range of fluids may be used with the printhead and an acceptable lifetime still achieved.

The present inventors have investigated this problem in an attempt to determine why even Parylene-coated electrodes are susceptible to corrosion. They have established that the effectiveness of the Parylene coating is dependent on the thickness of the coating applied and its integrity. Often it is not possible to apply a sufficiently thick layer of Parylene. Additionally or alternatively, the method of application such as by vapour deposition leads to the presence of imperfections in the coating such as pin holes or uncoated areas as a result of distance, direction and shadow effects. It is also possible that later steps in the manufacturing process of the printhead cause damage to the Parylene layer that has been applied, breaching the integrity of the layer. All of these factors mean that it is often difficult and unlikely that a complete, impermeable Parylene layer is formed, with imperfections in the Parylene coating meaning that regions of the underlying metal electrode surface are exposed and hence vulnerable to corrosion. Even very small exposed metal regions are problematic. Having is established that the corrosion problem is due to imperfections in the Parylene coating, the present inventors then investigated how to address this problem, and experimented with various other or additional coatings, e.g. of polymer materials, and found that particularly good results were obtained with inert metal coatings.

It should be noted that corrosion in inkjet printheads is distinct from kogation occurring in thermal inkjet printheads. Corrosion can occur in any inkjet printhead (piezo or thermal) due to the presence of a metal conductor in contact with the ink. Kogation is a separate and specific issue for thermal inkjet where the heat applied to the resistor in the printhead causes material to deposit onto the surface of the heater resistor, and leads to eventual printhead failure. The approach described herein is concerned with corrosion resistance and prevention, and not kogation.

### SUMMARY OF THE INVENTION

In one aspect, the present invention provides an inkjet printhead having at least one internal electrode in contact with ink in use, wherein exposed metal region(s) of the internal electrode surface have a coating of inert metal. Thus metal region(s) of the electrode surface that would otherwise be exposed to contact with the ink in use are coated with inert metal.

The present invention also provides in a further aspect an inkjet printhead having at least one electrode, wherein exposed metal region(s) of the electrode surface have a coating of inert metal.

The reference to exposed metal region(s) of the electrode surface means metal region(s) of the electrode surface that would otherwise be exposed, but for the inert metal coating.

The electrode is of a non-inert conductive metal such as copper, nickel, aluminium or silver or a combination of two or more of these metals, e.g. nickel-coated copper.

In practice, a printhead has many electrodes, and each electrode of the printhead has inert metal coating on exposed metal regions.

In use of the printhead, the inert metal coating functions to protect the underlying metal surface of the non-inert metal electrode, and in particular protects the electrode from corrosion on exposure to fluids that contain ions, typically aqueous inkjet inks, thus addressing the problem noted above.

The inert metal is chemically unreactive and so is resistant to corrosion, and typically comprises a noble metal, particularly gold and/or platinum.

The inert metal coating need not be particularly thick, provided exposed metal region(s) of the electrode are fully covered, and it is thought that thicknesses of only a few nanometers, e.g. a few tens to hundreds of nanometers, are effective. Thicker coatings may, of course, also be used.

It is only necessary for the inert metal coating to be present on exposed metal regions on parts of the electrode surface exposed to inkjet ink in use, but additional parts of the electrode surface may optionally also be coated.

The entire surface of the electrode exposed to ink in use may be coated with inert metal, constituting a corrosion-resistant protective coating. Alternatively, the surface of the electrode may have a protective coating constituted in part by a coating of a corrosion-resistant protective material, typically a polymer material, such as a xylene-based material, particularly a substituted or unsubstituted polyparaxylxyene material such as those known as Parylene, e.g. Parylene N, Parylene C and Parylene D, or other non-metallic protective coating, with the remainder of the protective coating constituted by inert metal. Typically, a coating e.g. of Parylene material is applied first, and then inevitable gaps and imperfections in the Parylene, leaving exposed metal, are filled by depositing inert metal.

The inert metal is preferably deposited from solution, e.g. aqueous solution. Suitable techniques are well known and include immersion plating, electroless plating and is electrolytic plating, with the inert metal being plated out from solution. Solution-based techniques are simple and straightforward and result in high quality inert metal coatings, lacking imperfections. Such techniques also selectively deposit inert metal only on conductive regions of the electrode, i.e. only exposed metal regions of the electrode and not, say, Parylene-coated regions, and hence only on those areas of the electrode vulnerable to corrosion. The treatment is thus effectively targeted to only those areas of the electrode where it is required, thus making highly efficient use of the inert metal material.

The inert metal coating may be formed on the electrode at any desired stage, before, during or after printhead production, and may be formed before or after any other electrode coatings, e.g. of Parylene.

A single coating of inert metal may be used, or multiple coatings, possibly of different inert metals or other materials, may be employed if desired.

An insulating layer may optionally be provided on top of the inert metal coating or coatings, e.g. in the form of a self-assembled monolayer (SAM) material such as dodecanethiol, to enhance further the protection achieved by the inert metal. Suitable materials and techniques are well known. The use of such a layer, e.g. of a SAM, provides the potential for enhanced durability of the electrode, with a non-metallic, non-conductive surface presented to ink in the printhead on use.

Deposition of the inert metal coating may be carried out on the electrode in situ in the printhead, and this may be readily achieved using solution-based deposition techniques such as those referred to above. For example, the treatment solution, e.g. an aqueous gold solution, may be put directly into the printhead to be treated, and left for a suitable time at a suitable temperature for inert metal plating to occur. Alternatively, the treatment solution may be put into the ink system of an associated inkjet printer. The solution may be re-circulated through the printhead using the ink system for an appropriate treatment time. It may be beneficial to exercise (energize) the printhead electrodes during the process to maximize plating efficiency and consistency. The treatment solution will enter and contact all areas of the printhead is that an ink may come into contact with, potentially causing corrosion, and so the process will selectively treat all exposed metal regions vulnerable to corrosion in a highly targeted and efficient manner.

A further advantage of the approach of the invention is that the deposition of inert metal may be applied to an inkjet printhead post-production (i.e. on a fully assembled printhead) without the need for disassembly of the printhead. The treatment therefore need not necessarily be applied by the manufacturer of the inkjet printhead. Indeed, the treatment can be readily readministered at intervals during the lifetime of a printhead, to coat or recoat with inert metal any metal regions of the electrode surface that may have become exposed in use, e.g. by damage or corrosion, thus further extending the lifetime of the printhead.

The invention is applicable to any inkjet printhead in which electrodes are exposed to contact with ink in the printhead in normal use, but is of particular benefit with piezoelectric printheads, particularly shared wall piezoelectric printheads where corrosion problems are more prevalent. This is because shared wall piezoelectric printheads have a series of side by side channels through which ink flows in use, with electrodes running down the sides of the ink channel walls, so the printheads have large areas of electrodes that are potentially exposed to/immersed in ink in use. Use of the invention means that the printheads can be used with a wider range of inks than was possible hitherto, particularly electrically conductive inks (aqueous and non aqueous) e.g. ion-containing inks such as water-based inks, e.g. those widely used in textile printing.

The invention also finds particular application to inkjet printheads with ink recirculation capability. The invention is particularly beneficial to this type of printhead as the recirculation of the ink rapidly and automatically removes any gas bubbles (generated by electrolysis of the ink occurring at the inert metal surface of the electrodes) in normal operation and so keeps the printhead operating correctly.

In a further aspect, the invention provides an inkjet printhead having at least one metal electrode, wherein at least the parts of the electrode surface exposed to ink in use have a corrosion-resistant protective coating constituted at least in part by a coating of inert metal.

The protective coating may be constituted entirely by inert metal.

Alternatively the protective coating may be constituted in part by a polymer coating such as a xylene-based material, particularly a substituted or unsubstituted polyparaxylxyene material such as those known as Parylene, e.g. Parylene N, Parylene C and Parylene D, or other non-metallic protective coating, with the remainder of the protective coating constituted by inert metal.

The invention also includes within its scope an inkjet printer including a printhead in accordance with the invention.

In a further aspect, the invention provides a method of treating an inkjet printhead electrode, comprising depositing inert metal on exposed metal region(s) of the electrode surface.

Inert metal is preferably deposited from solution, e.g. aqueous solution, for instance using plating techniques including immersion plating, electroless plating and electrolytic plating. The coating may initially be deposited using one technique, such as immersion plating, and then be made thicker using a secondary technique, such as electrolytic plating.

The method may be carried out before or after production of other coatings on the electrode, and is conveniently carried out after production of a coating of a substituted or unsubstituted polyparaxylxyene material, such as those known as Parylene, e.g. Parylene N, Parylene C and Parylene D.

The method may be carried out before, during or after printhead production, and is conveniently carried out on the electrode in situ in the printhead.

The method may be repeated, e.g. to deposit further inert metal (possibly different) on the initially deposited inert metal.

The method is conveniently repeated at intervals during the life of a printhead to repair any defects or imperfections that may develop in the protective coating, e.g. as a result of corrosion or damage, by depositing further inert metal on any newly exposed metal region(s) of the electrode surface, thus extending the useful lifetime of the printhead. An appropriate treatment schedule for a printhead can be determined, depending on the inks to be used in the printhead.

The invention also provides an inkjet printer reservoir containing an inert metal plating solution.

The invention will be further described, by way of illustration, in the following example and with reference to the accompanying drawing, in which:

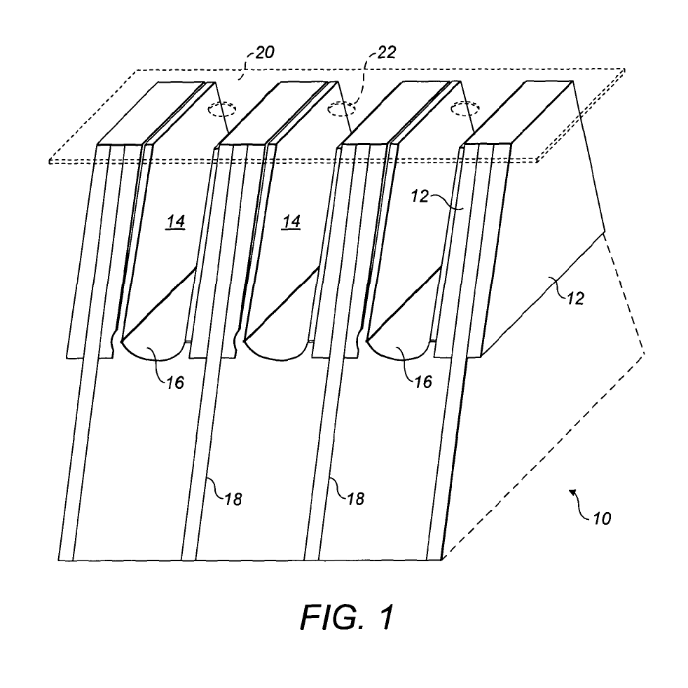

FIG. 1 is a schematic drawing representing part of a shared wall piezoelectric printhead.

### DETAILED DESCRIPTION OF THE DRAWINGS

FIG. 1 shows schematically part of a shared wall piezoelectric printhead 10.

The printhead is formed from a piece of piezoelectric material 12 that has a series of side-by-side channels 14 cut therein, constituting passages through which ink flows in use. The spacing between opposed side walls of each channel is about 70 micron. The entire surface within the channels and down the side of the channels is coated with non-inert metal, as indicated at 16, and forms electrodes typically of copper and/or nickel, e.g. nickel-coated copper. Metal is removed from regions 18 between adjacent channels so that the electrodes are isolated from one another. A faceplate 20 extends across the top of the channels, with a series of apertures 22 constituting a respective nozzle for each channel. In use, the wall is activated by having a voltage applied across it, i.e. the electrode on one side is positive and the one on the other side is negative, resulting in deformation of the piezoelectric material 12 to expel a drop of ink from the nozzle.

### EXAMPLE

Printhead Treatment

Experiments were carried out using Xaar 1001 (Xaar is a Trade Mark) shared wall piezoelectric printheads, which have non-inert conductive metal electrodes coated with Parylene polymer, that were treated with a gold plating solution as described below.

0.93 g of gold potassium cyanide (Metalor Technology) is dissolved in 20 ml of deionised (DI) water. 225 g of Aurolectroless SMT MakeUp solution (Aurolectroless is a Trade Mark) (Rohm & Haas Electronic Materials) is added to a clean glass beaker. Whilst stirring, the dissolved gold potassium cyanide solution is added to the Aurolectroless SMT solution. The resulting gold plating solution is then made up to 300 ml, with DI water. The solution is then heated to 85° C. The printhead to be treated is placed in an oven at 85° C., loosely wrapped in aluminium foil. After 30 minutes, the printhead is removed from the oven and placed on a retort stand with clamps in close proximity to the plating solution. A tube was attached to the outlet of the printhead and routed to a 1000 ml beaker of gold plating solution at 85° C. A 20 ml syringe is filled with hot gold plating solution, and connected to the inlet tubing. The hot solution was flushed through the printhead, fully depressing the syringe over approximately 5 seconds. The solution is passing through the head and back into the 1000 ml beaker. The syringe is immediately fill a second time and flush through the printhead, until the solution can be seen in the outlet tube where it was held for 3 minutes, ensuring there was always solution in the outlet tube. After 3 minutes dwell, the syringe is fully depressed. The flushing process is repeated a third time, but this time the solution is held for 6 minutes.

Once this third flushing is complete, and the syringe fully depressed, the outlet pipe is redirected to a waste container, and the syringe replaced with another filled with DI is water at room temperature. 3×20 ml syringes of room temperature (about 20° C.) DI water is passed through the printhead which is then re-wrapped in the aluminium foil and placed in an oven at 85° C., and left for a further 30 minutes.

The printhead is then removed from the oven, unwrapped and reconnected to the tubing, ensuring that the outlet pipe has been redirected to the 1000 ml beaker of gold plating solution. The printhead is flushed with the plating solution through once more, holding in the printhead for 6 minutes and finally, flushed through another 3×20 ml DI water.

This treatment results in the gold solution spontaneously plating a layer of gold (estimated to have a thickness of about 0.08 microns after 15 minutes treatment and 0.1 microns after 30 minutes) onto any exposed metal regions of the electrode surface, particularly where there are any imperfections or permeable regions of the Parylene coating that allow the gold solution to come into contact with the underlying electrode surface, thus producing a printhead in accordance with the invention.

The resulting gold regions have been found to be highly corrosion resistant when the inkjet printhead is subsequently used with aqueous inks, thus significantly enhancing the lifetime of the printhead.

Jetting tests were carried out to compare printheads treated as described above with untreated printheads. In particular the printheads were tested with an aqueous inkjet ink printed continuously through all of the printhead nozzles (1000), with nozzle loss being determined at periodic intervals.

Printhead Testing

The treated printhead is connected to a PC with drive electronics via a Head Personality Card (available from Xaar Plc) and the fluid path attached to a small volume recirculation ink management system (available from Xennia Technology is Ltd).

The printhead is secured by a retort stand and is suspended above an ink collection system. This collection system is positioned above a collection pot with the base just below the lip of the pot to ensure all ink is collected. The whole assembly is thoroughly cleaned and drained prior to the start of the experiment.

Printing tests were carried out with an aqueous ink formulation with the formulation (in % by weight) set out in the following table.

| Material | Supplier | Ink | |
|---|---|---|---|
| Cab-o-jet 300 | Cabot | 1.0 | Carbon black pigment dispersion |
| DI Water | Brenntagg | 98.52 | |
| Blanose 12M31P | Eastman | 0.1 | Sodium carboxymethyl cellulose |
| Octanol | Sigma- | 0.02 | |
| | Aldrich | | |
| Tego Wet 280 | Evonik | 0.36 | Polyether silosane copolymer |
| | Total | 100 | |

| | |
|---|---|
| Viscosity @ 25 C./cP | 8.45 |
| Surface Tension/Dynes.cm⁻¹ | 25.5 |
| Conductivity/μS | 200 |
| pH | 8 |

Prior to the start of the jetting, the ink is re-circulated into the system through the printhead for 10-15 minutes. The 250 mL-ink collection pot is half filled with ink and the ink system fill tube is fully immersed into the ink collection pot. A float switch in the intermediate reservoir of the ink system controls the liquid level and, if low, opens a valve to fill the system from the 250 mL-ink collection pot. Thus, the ink is continuously jetted into the ink collection pot which then gets loaded back into the ink system.

Prior to the start of the experiment, the head is positioned onto a translation table and a nozzle print test pattern is printed. This print target enables assessment of the number of missing nozzles. Maintenance strategy such as priming and spitting is used at this stage to get all the nozzles working. Adjustment of the voltage and meniscus pressure is also carried out at this stage. Once a good print has been produced, the is head is returned to the ink collection system.

The printhead is then subjected to continuous jetting of the highest grey level at 6 KHz, 100% up-time and 100% duty cycle. The software used to treat the image processing data is XUSB (available from Xaar Plc). During the continuous jetting experiment, the ejection of the drops is controlled by internal signals. The printed image is a solid block triggering the highest grey level of the printhead width by 2000 pixels in the scan direction.

After an hour of printing, the printhead is placed again on the translation table and several samples are printed. At this stage, priming and wiping the face plate may be necessary to help improving the print. The printhead is then returned to the ink collection pot. To assess the jetting stability a nozzle check print sample is required at regular intervals, once every hour for the first 6 hours, once every two hours for the next 6 hours. After 20 hours, the periodicity of the nozzle check print sample is reduced to twice a day, morning and evening. At this point the printhead is left to jet continuously.

After every 48 hours of continuous jetting, a sample of the printed ink is taken for full physical properties characterization. If there are any significant changes in the physical characteristics then the ink is replaced.

For each time interval data point, print sample assessment is performed on the 3 best possible quality print samples. All the 3 samples should be compared when counting the number of missing nozzles; if a nozzle is missing in one print but present in another then it is classified as present and only if a nozzle is vacant in all 3 prints, is it classified as missing. Information should be collected for each row, if the printhead has more than one.

The data collected is then assessed and classified as <1% nozzles missing, <10% nozzles missing, <50% nozzles missing. Once a printhead has lost >50% nozzles the experiment is stopped. The printhead is then flushed to remove all ink. A is standard solvent-based test fluid is then loaded into the printhead and a nozzle check print is taken to confirm the total nozzle loss results.

The results for 2 treated printheads and 1 untreated printhead are given in the tables below, with Tables 1 and 2 showing results for the treated printheads, and Table 3 the results for the untreated printhead.

TABLE 1

| | Nozzle loss | |
|---|---|---|
| Jetting hours | TOTAL | % |
| 0 | \ | |
| 1 | 1 | 0.1 |
| 17 | 2 | 0.2 |
| 41 | 1 | 0.1 |
| 65 | 2 | 0.2 |
| 72 | 2 | 0.2 |
| 88 | 5 | 0.5 |
| 90 | 3 | 0.3 |
| 110 | 12 | 1.2 |
| 118 | 10 | 1.0 |
| 135 | 22 | 2.2 |
| 152 | 39 | 3.8 |
| 158 | 41 | 4.0 |
| 176 | 48 | 4.7 |
| 200 | 93 | 9.2 |
| 220 | 74 | 7.3 |
| 227 | 81 | 8.0 |
| 243 | 130 | 12.8 |
| 249 | 121 | 11.9 |
| 273 | 212 | 20.9 |
| 314 | 220 | 21.7 |
| 333 | 449 | 44.2 |
| 360 | 928 | 91.3 |

TABLE 2

| | Nozzle loss | |
|---|---|---|
| Jetting hours | TOTAL | % |
| 0 | 6 | 0.6 |
| 7 | 24 | 2.4 |
| 23 | 34 | 3.3 |
| 28 | 21 | 2.1 |
| 46 | 22 | 2.2 |
| 66 | 26 | 2.6 |
| 70 | 22 | 2.2 |
| 88 | 31 | 3.1 |
| 112 | 29 | 2.9 |
| 136 | 45 | 4.5 |
| 143 | 41 | 4.1 |
| 160 | 63 | 6.3 |
| 168 | 85 | 8.5 |
| 183 | 94 | 9.4 |
| 206 | 99 | 9.9 |
| 229 | 106 | 10.6 |
| 251 | 320 | 32.0 |
| 274 | 931 | 93.1 |

TABLE 3

| | Nozzle loss | |
|---|---|---|
| Jetting hours | TOTAL | % |
| 0 | 0 | 0.0 |
| 1 | 18 | 1.8 |
| 2 | 176 | 17.3 |
| 3 | 209 | 20.6 |
| 4 | 323 | 31.8 |
| 5 | 261 | 25.7 |
| 6 | 300 | 29.5 |
| 9 | 574 | 56.5 |
| 11 | 798 | 78.5 |

Nozzle loss of up to 10% is considered practically acceptable for some uses. It should be noted that some nozzle loss is temporary, e.g. being caused by air bubbles, accounting for nozzle recovery in some cases.

The results show that the untreated printhead failed rapidly and developed unacceptable nozzle loss after less than 2 hours jetting. This was due to corrosion of the Parylene-coated electrodes. In contrast, the treated printheads in accordance with the invention withstood jetting for over 200 hours before developing unacceptable nozzle loss.

1. An inkjet printhead having at least one internal electrode in contact with ink in use, wherein exposed metal region(s) of the internal electrode surface have a coating of inert metal.

2. A printhead according to claim 1, wherein the inert metal comprises gold and/or platinum.

3. A printhead according to claim 1, wherein the entire surface of the electrode is coated with inert metal.

4. A printhead according to claim 1, wherein the surface of the electrode has a protective coating, with gaps in the protective coating having a coating of inert metal.

5. A printhead according to claim 4, wherein the protective coating comprises a substituted or unsubstituted polyparaxylxyene material.

6. A printhead according to claim 1, comprising one or more further coatings of inert metal.

7. A printhead according to claim 1, comprising an insulating layer on top of the inert metal.

8. A printhead according to claim 1, comprising a piezoelectric printhead.

9. A printhead according to claim 8, comprising a shared wall piezoelectric printhead.

10. A printhead according to claim 1, wherein the printhead has ink recirculation capability.

11. An inkjet printer, comprising a printhead in accordance with claim 1.

12. A method of treating an inkjet printhead internal electrode, comprising depositing inert metal on exposed metal region(s) of the electrode surface.

13. A method according to claim 12, wherein the inert metal is deposited from solution.

14. A method according to claim 12, wherein the inert metal is deposited by immersion plating, electro less plating or electrolytic plating.

15. A method according to claim 12, wherein the inert metal is deposited on the electrode in situ in the printhead.

16. A method according to claim 12, wherein the method is repeated at intervals.

17. An inkjet printer reservoir containing an inert metal plating solution.
